(19) United States
(12) Patent Application Publication
(10) Pub. No.: US 2014/0195392 A1
(43) Pub. Date: Jul. 10, 2014

(54) SYSTEMS AND METHODS USING A BUSINESS OBJECT LIFECYCLE FOR MANAGEMENT OF BUSINESS RECORDS MAINTENANCE

(71) Applicant: ORACLE INTERNATIONAL CORPORATION, Redwood Shores, CA (US)

(72) Inventors: Wesley CURTIS, Cary, NC (US); Karel P. CRIGAN, Berkeley, CA (US)

(73) Assignee: ORACLE INTERNATIONAL CORPORATION, Redwood Shores, CA (US)

(21) Appl. No.: 13/777,261

(22) Filed: Feb. 26, 2013

Related U.S. Application Data
(60) Provisional application No. 61/750,399, filed on Jan. 9, 2013.

(51) Int. Cl. G06Q 40/00

(52) U.S. Cl. CPC G06Q 40/103
USPC 705/31

(57) ABSTRACT

Systems, methods, and other embodiments associated with using a business object lifecycle for management of business records are described. In one embodiment, a method includes defining a lifecycle for a customer tax role record having a plurality of possible lifecycle states. Subsequent to defining the lifecycle, the method monitors a plurality of customer tax role records that have an active state, and for a monitored record, determines if an expiration date has expired. If the expiration date has not expired, then a new tax obligation is generated for a customer associated with the monitored record. If the expiration date has expired, the state of the lifecycle state of the monitored record is changed to an expired state such that the new tax obligation is not generated. The method then repeats the monitoring for a next active record from the plurality of customer tax role records.

### CROSS REFERENCE TO RELATED APPLICATIONS

This disclosure claims the benefit of U.S. Provisional Patent Application serial number “61/750,399” filed Jan. 9, 2013, titled “Systems and

Methods Using a Business Object Lifecycle for Management of Business Records Maintenance”, inventors: Wesley Curtis and Karel P. Crigan, and assigned to the present assignee, and which is incorporated by reference in its entirety.

### BACKGROUND

A corporate organization may have enterprise applications that include a collection of computer programs with common business applications, tools for modeling how the organization works, and development tools for building applications unique to the organization. The applications may be configured to solve an enterprise-wide problem, rather than a departmental problem. In general, enterprise level software may aim to improve the enterprise's productivity and efficiency by providing business logic support functionality for particular processes.

In some applications, the enterprise may be configured to track business items. For example, the enterprise may track relationships between customers and one or more entities such as for example obligations of the customers relative to the one or more entities. Examples of obligations include obligations of tax payers to taxing authorities such as for example State and Federal taxing authorities. The obligations often are tracked with respect to dates and other legal and/or financial information. In addition, the status of the customers relative to the one or more entities may change from time to time and therefore the obligations of the customers relative to the entities may be implicated.

Tracking these types of business items can be a difficult task, particularly when there are a large number of customers and a large number of quickly changing obligations. Complications in tracking these business items arise when for example, the status of a customer may change because of legal or other financial reasons thereby affecting a corresponding set of changes in the obligations owing to the entity by the customer. Further complications may occur when the changing obligations of a customer are owed to more than one entity.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments one element may be designed as multiple elements or that multiple elements may be designed as one element. In some embodiments, an element shown as an internal component of another element may be implemented as an external component and vice versa. Furthermore, elements may not be drawn to scale.

FIG. 1 illustrates an example overview of objects and a lifecycle according to an example embodiment of a method associated with a tax role object.

FIG. 2 illustrates an embodiment of a method associated with using a business object lifecycle for management of business records maintenance.

FIG. 3 illustrates a method according to an embodiment.

FIG. 4 illustrates a method according to an embodiment.

FIG. 5 illustrates an embodiment of a computing system configured to operate the example systems and methods of the example embodiments of FIGS. 3 and 4 and equivalents thereof.

FIG. 6 illustrates one embodiment of a business object lifecycle.

FIG. 7 illustrates an example graphical user interface associated with addition and selective execution of one or more auxiliary or supplemental logic for an “Active” state of a business object.

FIG. 8 illustrates an example graphical user interface associated with addition and selective execution of one or more auxiliary or supplemental logic for a “Canceled” state of a business object.

FIG. 9 illustrates an example graphical user interface associated with addition and selective execution of one or more auxiliary or supplemental logic for selective execution.

### DETAILED DESCRIPTION

Systems, methods, and other embodiments are disclosed herein for managing data maintenance using a business object lifecycle. In one embodiment, a computer system is configured for business record processing and rules that use a business object lifecycle for data maintenance management. The example embodiment is described with reference to a system and process for managing tax registration information using the lifecycle of a tax role business object. The example embodiments find particular application in enterprise taxation and policy management systems. However, it is to be understood that the embodiments are applicable and provide benefits in any logic or system wherein data of any type is maintained and wherein management of the data maintenance is performed. In one embodiment, the system provides an enhancement that allows tax authorities to monitor taxpayer compliance with filing requirements that automates the complexity that occurs when there are changes to the tax payer's filing frequency (e.g., monthly filing obligations to quarterly filing obligations, vice versa, etc.).

In accordance with one embodiment, the present system is implemented in an enterprise taxation and policy management system, wherein specific transactional objects and selected objects related to registration details of a taxpayer are modeled as a tax role business object. Product teams define logic for executing maintenance on the registration details such as, for example, monitoring the tax role for extended inactivity and for validating updates of tax roles or other registration details. The tax role business object is logically associated with a business object lifecycle wherein the processing rules and logic for monitoring the taxpayer registration details are segmented by the product development team. The segmentation of the business object and use of the business object lifecycle provides the opportunity to implementation teams to selectively turn ON, turn OFF or ADD specialized processing logic to augment the maintenance logic inherent in the system as provided by the product development team, thereby providing enhanced database maintenance.

Overall, therefore, systems and methods are described herein that provide for generation and use of one or more business object lifecycles for enhanced management of business records maintenance. More particularly, systems and methods are described herein that provide for generation and use of the lifecycle of a tax role business object for enhanced management of customer tax role data. This includes monitoring the filing obligations of a tax payer and automatically creating the next obligation for the next filing period (e.g., next month, next quarter, etc) based on the defined lifecycle and current state of the tax role record for the tax payer. Tax filing obligations may define that certain tax forms or documents be filed with a tax authority at the specified filing periods as identified in each record (tax role).

For ease of discussion and understanding, embodiments herein are described in connection with tax authority administration. However, it is to be appreciated that the underlying application of the systems and methods herein is not limited to tax authority use, but that the principles and examples herein can be extended to any business related data processing system as well as to any others wherein one or more business objects that change over time are used.

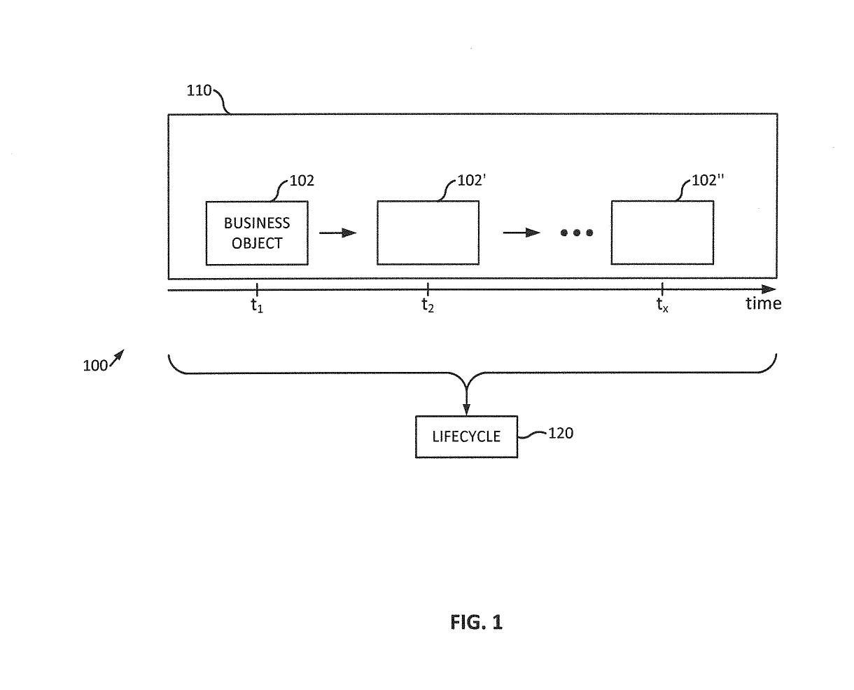

In one embodiment, and with reference to FIG. 1, a timeline of changes to a business object 110 is shown as a series of business object instances with different representative instances occurring at various points in time t₁, t₂, . . . tₓ. The business object 110 is created in accordance with a procedure 100 relative to associated business records maintenance application logic. In the example embodiment, consider that the business object 110 is created and is represented as an initial instance of a business record 102 at an initial time t₁. The business object 110 is a representation of a maintenance object or a related set of database tables used by the business records maintenance application logic. More particularly, although not so limited, the business object 110 is a tax role business object representative of a container or folder for a related set of tax filings as part of an entity's taxpayer record in an associated system (not shown in FIG. 1) configured to execute the business records maintenance application logic.

In practice, over time the nature of a taxpayer's interaction with the tax authorities can change. For example, individuals may move into and out from certain tax authorities such as moves from state to state. Also, the nature of a registration of a business may change such as the need to file for different taxes over time. Tax filing frequencies may change, as well as some aspects or details of the entity's business which may change over time.

As these changes occur over time, it is typical that many business rules are applied and evaluated as the entity's business record is updated over time. Therefore, as shown in the Figure, the business object 110 in an initial state or instance 102 at time t₁ is transitioned at time t₂ to the business object instance 102′ having a second state. The business object instance 102′ reflects a change in the tax entity's situation (e.g., changes in the tax role business record) from the initial creation of the business object 110. The business object instance or record 102′ in the second state is further transitioned at time tₓ to the business object instance or record 102″ in an x^{th} state to represent additional changes in the tax role business object 110 of the entity over time. It is to be appreciated however that the tax role may be updated in the example embodiment and remain in the same or current existing state, and further that business rules may be executed on updates or when changing to a different state.

The majority of the complexity of business maintenance processing and rules manifest when these changes occur to the business records over time. The object instance or record 102 initially created using an initial set of rules typically requires reevaluation and new representations such as at 102′ and 102″ and, in some cases, it may become necessary to reevaluate the entire set of records that are related to the individual entity. The reevaluation typically involves and uses a large amount of complex processing logic and evaluation logic to make sure that these updates that are performed over time are properly updated, validated, and saved to a data storage medium in the system.

In one embodiment, the business object transactional instance 102 is logically related to a lifecycle 120. For example, the business object transactional instances 102, 102′, 102″ are logically related to a lifecycle 120 by a product team with access and adequate privilege to make substantive changes to the underlying set of business logic rules of the application logic. The lifecycle is a representation of the changes in the business transactional instances 102, 102′, and 102″ over time. In the example embodiment, the lifecycle of a selected object, namely the tax role business object transactional instance or record 102, is defined exclusively by an application logic product team, wherein the product team may define and/or change the operation of the tax role record 102. In addition, in the example embodiment, the lifecycle is selectively segmented by the application logic product team.

However, in accordance with the example embodiment, installation teams selectively modify the basic transactional and maintenance logic performed by the application logic as determined by the product team. For example, auxiliary rules logic determined and/or developed by the installation teams may be executed in addition to or instead of the basic business logic rules provided by the product team. That is, within the lifecycle, the installation teams are provided with an option to add custom specific processing logic at different points in the lifecycle 120 of the business object 102, 102′, and 102″. In this way, therefore, the installation teams can better manage business rules for themselves that may differ from other business processing or maintenance rules as initially set into place by the product team.

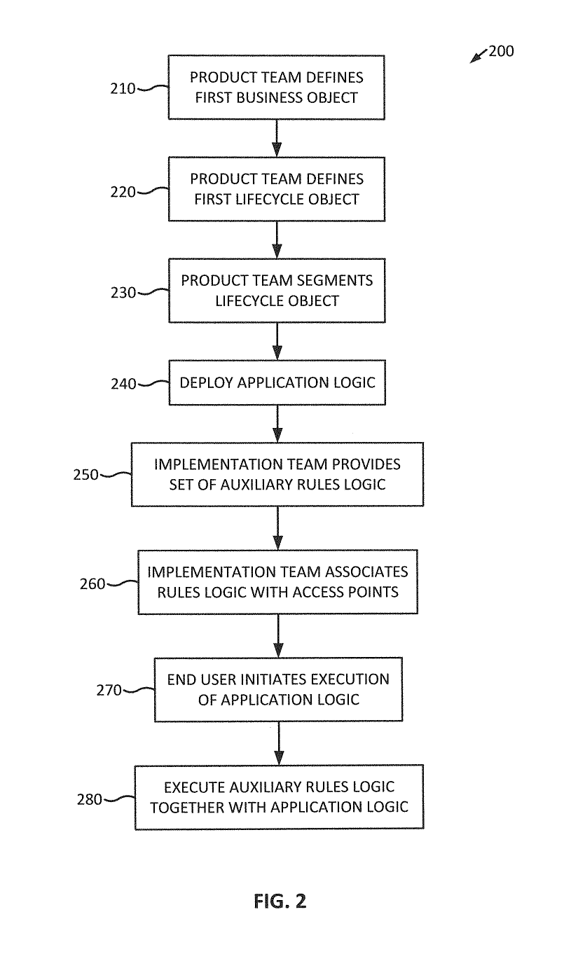

With reference to FIG. 2, one embodiment is illustrated of a method 200 associated with using a business object lifecycle for managing the maintenance of business data by an example computer system. The business data is managed in response to stimulus from one or more invocations of maintenance activities on tax role records or from inputs from an associated user using a graphical user interface of an application executing in the computer system. As noted above, the embodiments are described herein with reference to an example embodiment wherein the application logic is a computer-implemented enterprise taxation and policy management system and the business object is a tax role object. However, the embodiments are not so limited. At 210, a first business object is defined by an associated product team responsible for developing overall application logic of the system. In the example embodiment, the product team (also referred to as an application logic development team) generates the application logic (e.g. executable code) and defines the first business object (e.g. tax role object) relating to the application logic and for executing a set of business rules. The database object in accordance with the example embodiment is associated with customer tax records which may include data from multiple relational database tables. The database object may also include information concerning structures and/or arrangements of the databases and/or of the data contained within the databases. The tax record database object of the example may store information relating the taxpayer in a taxpayer information table, an obligation table, a financial organization table, a legal entity table, and others.

At 220, a lifecycle is defined for the first business object. In general, the lifecycle is defined by the product team at a time of configuration of the system records wherein the lifecycle is representative of the plurality of states of the tax role business object template. At 230, the lifecycle is segmented. More particularly, in the example embodiment, the application logic development team segments the business object lifecycle for reasons including to provide access points for selective execution of auxiliary or supplemental logic as desired by one or more product implementation teams. Business records processing rules logic are associated with selected states of the tax role record when the tax role record is in various or different states.

The application logic is deployed at 240 to an end user of the application logic and, at 250 the implementation team provides a set of auxiliary rules logic for selective execution at corresponding segments of the segmented business object. In the example embodiment, transition of the business object between segments urges the execution of selected one or more portions of the auxiliary rules logic. As an example, changes in the lifecycle state may be used as a trigger to urge the execution of selected one or more portions of the auxiliary rules logic as will be described in greater detail below. In other examples, changes made to the customer tax role data or changes in status of obligations of the taxpayer in accordance with the passing of time relative to past due or future obligations may also serve as trigger events. A trigger event initiates the execution of one or more portions of the auxiliary rules logic as will be described in greater detail below. Also in the example embodiment, the auxiliary rules logic provide a layer of executable logic operable to add to, subtract from, and/or supplement operations performed by the underlying application logic. In this way and in accordance with the embodiment, selected needs of the implementation team based on requirements at the deployment site may be provided directly by the implementation team without the need for intervention by the product team. As an example, the implementation team may selectively add to, subtract from, and/or supplement operations performed by the underlying application logic based on development by the product team. This allows the first business object or the underlying application logic to be redeveloped (reprogrammed) as desired by the implementation team for purposes of configuring the application logic by the set of auxiliary rules logic for customized use at a site of an associated end user.

With continued reference to FIG. 2, at 260, the implementation team associates a set of auxiliary rules logic with corresponding access points provided in the business object by the product team during development of the application logic and implementation of the configurable tax role business object template and related lifecycle.

The end user of the application logic may selectively add or update business records which in turn in an example embodiment initiates execution of the application logic at 270. However, it is to be appreciated that the application logic is executed when installed and activated with or without end user intervention and may function to simply monitor one or more tax payer obligations relative to a taxing authority over time. Responsive to the execution of the application logic, the set of auxiliary rules logic is executed or otherwise performed by a computer at 280 together with the set of business rules in accordance with the underlying application logic. As described, selected portions of the set of auxiliary rules logic are executed in accordance with their relative association with respective segments of the business object. In this way, the lifecycle of the business object is used to manage business records maintenance as performed by the underlying application logic.

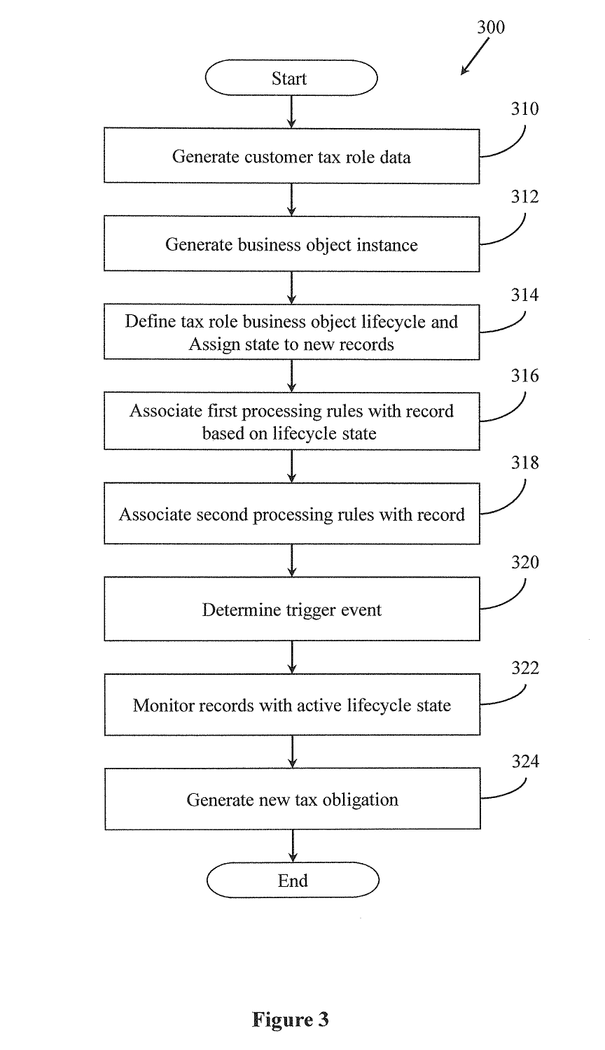

FIG. 3 is one embodiment of a flow chart illustrating a method 300 in accordance with an embodiment wherein a business record system including a processor and a non-transient memory is configured to perform the method 300. At 310, a customer registration record is stored in a non-transient memory of the associated system. In the embodiment, the customer registration record is configured to represent an obligation relationship of an associated customer relative to an associated entity. More particularly, in the example embodiment, the customer registration record includes one or more tax roles, each of which controls a set of one or more obligations. Further, in the example embodiment, the tax role record comprises a tax role business object having one or more business object instances as shown in the flow chart at 312, wherein the tax role business object defines a lifecycle at 314 having a plurality of possible states including at least Active, Expired, and Canceled states representative of selected instances of the business object. At 312, the customer tax role record is created and stored by the product team wherein the customer tax role record is representative of an obligation relationship of an associated customer relative to an associated tax authority. The tax role record in the example embodiment comprises a tax role business object, wherein the tax role business object comprises a tax role business object lifecycle having a plurality of states representative of selected instances of the tax role business object. Initially, business object (customer record) is assigned an active state.

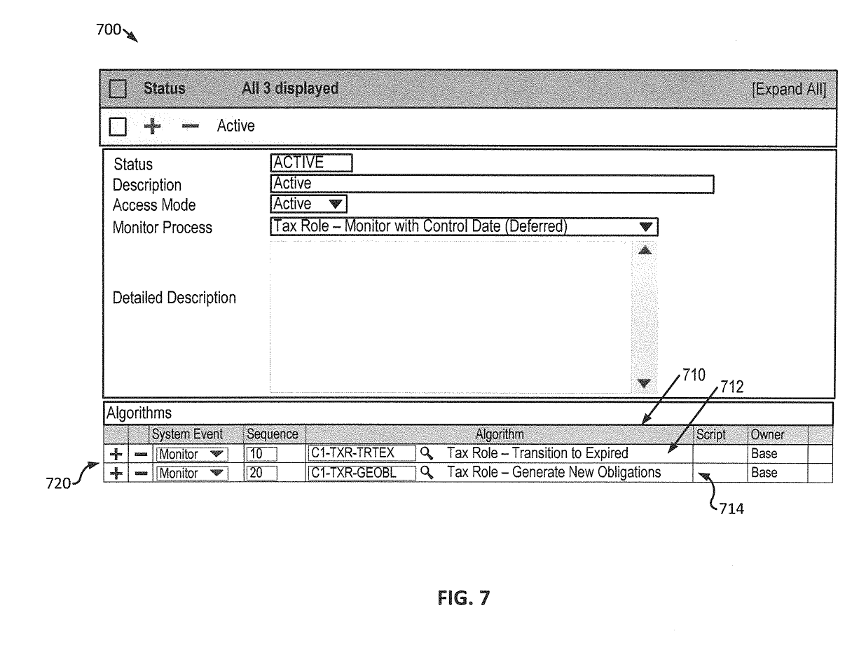

At 316 and 318, various processing rules may be associated to the tax role business object (e.g., a tax registration record for a customer). For example, the processing rules may be algorithms that are performed based on the lifecycle state of the associated record, tax obligations defined in the record, and/or other conditions. These rules/algorithms are generically represented in FIG. 3 as first and second processing rules that are associated to a business object/record although any number of rules can be associated with a record. In one embodiment, the algorithms can be linked to a record and/or identified in a record (see FIG. 7, element 710 that shows algorithms for a record). A rule can be configured to be executed upon a predefined event (e.g., generate next tax obligation based on selected dates). Some rules perform maintenance on tax role information in a registration record such as modifying names, addresses, obligation periods, or other customer data or parameters in the record. A user may also perform maintenance on a record directly via the system interface. Performing maintenance may in turn trigger the execution of other code, for example, code that validates any changes made to the record to ensure the changes are permitted and/or valid. In the embodiment, the first and second processing rules may include updating the customer registration record and revising obligation relationships of the customer relative to other customers and/or relative to other entities in accordance with the updating of the customer registration record.

At 320, a data trigger event is determined. In one example embodiment, determining the trigger event comprises determining a transition of the tax role business object lifecycle between first and second states of the plurality of states of the lifecycle, wherein the first and second states are mutually different states of the lifecycle. In another example embodiment, determining the trigger event comprises receiving from a user of the computer system update data that modifies the customer tax role record. Modifying certain data in the tax role triggers the execution of validation code/rules as stated above to verify that the modifications are valid.

At 322, determining the trigger event may include a monitoring process that periodically monitors tax role records that have an active state. For each active records, the process compares the obligation relationship of the associated customer relative to the associated tax authority with a current time and determining the trigger event in accordance with an unfulfilled obligation based on the periodic comparing. In other words, if the next tax obligation is approaching for an active record and an obligation due date specified in the record has passed; a new obligation is generated for the customer in accordance with the next obligation filing period (block 324). If an expiration date in the record has passed, then the record is transitioned to an expired state and no further obligations are generated.

It is to be appreciated that the custom records processing rules logic may be received and stored in a non-transitory memory for example prior to the initiation of the method 300 shown in the figure, rather than received in real time as needed. In the example embodiment, the custom maintenance logic is added to the static business object configuration.

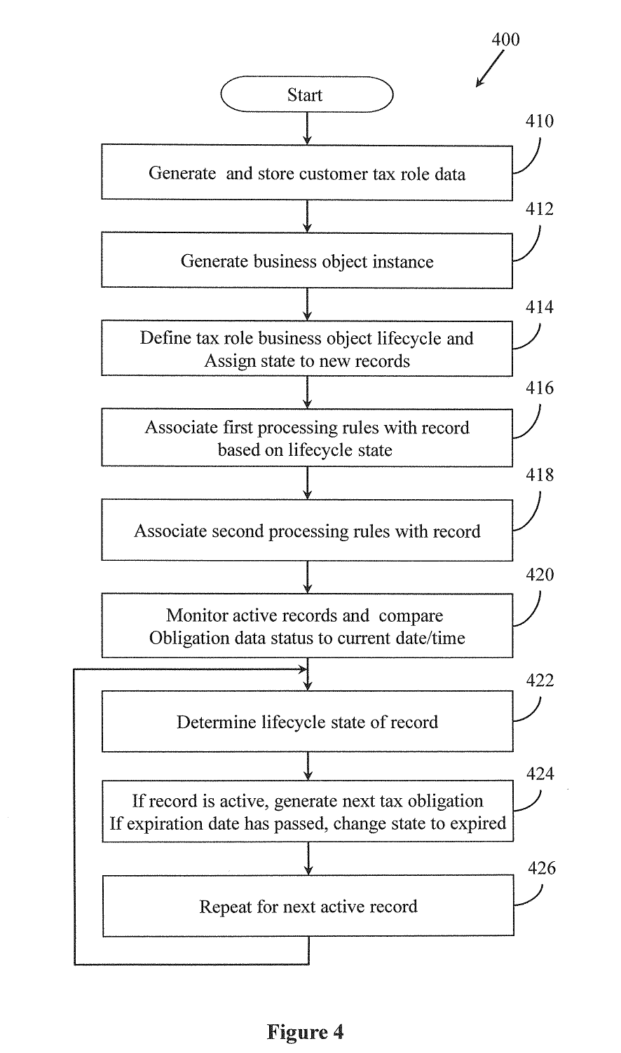

FIG. 4 is another embodiment of a flow chart illustrating a method 400 in accordance with an associated business record system including a processor and a non-transient memory that is configured to perform the method 400. At 410, a registration record (a business object) is created and stored for each tax customer. This may be regarded as a tax role record. The registration record includes one or more tax roles, each of which controls a set of obligations. The obligations, for example, specify what the tax customer is obligated to do and when such as file certain tax forms or other documents at a predetermined frequency (e.g., monthly, quarterly, etc.) and/or file the forms with an identified tax authority. After creation, each registration record begins a lifecycle (at block 414) and is assigned a state, which initially is an active state in the lifecycle. Other possible states that the registration record could transition to later on in its lifecycle include an expired state and a canceled state. Some registration records may include an expiration date after which the tax customer's obligations expire. For example, upon monitoring active records, if the current date is past the expiration date of a record, the system changes the record to an expired state. The obligations of expired records are then no longer continued.

The active records are periodically monitored and based on tax roles of a registration record, new obligations are automatically generated for a customer for the next tax obligation period. In one embodiment, the customer tax role record comprises obligation data representative of an obligation relationship of an associated customer relative to an associated tax authority. Further, the tax role record comprises a tax role business object, wherein the tax role business object comprises a tax role business object lifecycle that includes a plurality of possible states representative of selected instances of the tax role business object.

At 416 and 418, various processing rules (also called algorithms) may be associated to the registration record where the processing rules are performed based on its lifecycle state and/or tax obligations. These are generically represented in FIG. 4 as first and second processing rules although any number of rules can be assigned to a record. For example, one or more rules can be performed when the registration record is in an active state and an obligation period is triggered. For example, a new tax obligation is generated for a customer when triggered. One or more different rules can be triggered and performed if the record is modified such as modifying the tax role's name, address, other customer information, or tax obligation period, etc. When the record is modified, validation rules may be executed on the modified portions of the record to ensure that the modifications comply with any predefined requirements. One or more other rules can be performed if a record transitions to a canceled state. As one example, if a registration record is created based on a particular tax form and then the tax form is subsequently cancelled, the registration record is then changed to a cancelled state.

After the registration records are created and stored, the system periodically executes a monitoring process. Thus at 420, active registration records are monitored (e.g., by an executing batch process) and each active record is analyzed. At 422 for each active registration record, the lifecycle state is determined by determining if the record is still active or expired. The expiration date, if any, defined in the record is compared to the current date. At 424, if the expiration date has not passed, then the record remains active and the next obligation is generated for the next filing period as defined in the tax role of the record. This may include executing an algorithm, which has been assigned to the record, where the algorithm is configured to generate the next obligation. At 426, the method then repeats the process for the other active records. If at 422, the expiration date for the analyzed record has passed, then the active record is transitioned to an expired state and no further obligations are generated. The method continues to 426 and repeats for the next active record.

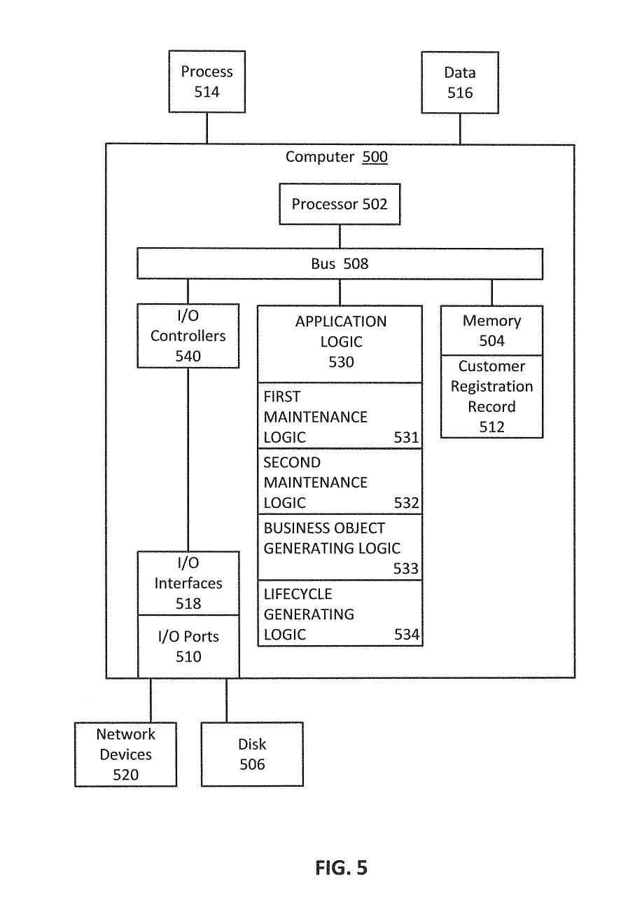

With reference to FIG. 5, one embodiment of a computer system 500 is illustrated that is configured with application logic 530 including programmed applications/algorithms for executing operations as described herein. The computer system 500 comprises at least a processor 502 and a non-transitory memory 504 coupled with the processor 502 via a bus 508. The memory 502 is configured to store one or more customer registration records 512 for one or more customers. In the embodiment described, the customer registration record 512 (tax role record) is representative of an obligation relationship of an associated customer relative to an associated entity. The computer system 500 also includes first maintenance logic 531 and second maintenance logic 532 for performing first and second maintenance operations on the customer registration record 512.

Business object instance generating logic 533 of the computer system 500 is operable to generate a business object 102, 102′ and 102″ (as shown in FIG. 1) representative of a status of an associated customer relative to an associated entity in accordance with the customer registration record 512 in a manner described herein.

Lifecycle data generating logic of the computer system 500 is operable to generate a lifecycle object 120 (shown in FIG. 1). In the embodiment, the lifecycle object 120 has at least first and second states representative of respective first and second statuses of the business object 102, 102′ and 102″ (shown in FIG. 1).

Further in accordance with the embodiment, the processor 502 is configured to associate the first maintenance logic 531 with the first state of the lifecycle object 120, and to associate the second maintenance logic 532 with the second state of the lifecycle object 120.

An input port 510 of the computer system 500 in accordance with embodiment is configured to receive, from an associated user of the system 500, update data modifying the customer registration record 512. In accordance with the embodiment, the processor 502 is responsive to the modifying of the customer registration record 512 to determine a state of the lifecycle object 120 and to selectively perform the first maintenance logic 531 for the lifecycle object 120 being in the first state and performing the second maintenance logic 532 for the lifecycle object 120 being in the second state.

Further in accordance with the embodiment, the computer system 500 is configured to receive custom maintenance logic from a user of the system 500 via a graphical user interface that receives input signals from I/O port 510. The custom maintenance logic may be received for example as described at block 250 of FIG. 2, block 328 of FIG. 3, or block 426 of FIG. 4. In response to the receiving the custom maintenance logic such as described herein, the processor 502 is configured to selectively perform the custom maintenance logic responsive to the modifying of the customer registration record 512.

The computer 500 may include one or more other components such as input/output (I/O) controllers 540, I/O interfaces 518 that control and communicate with the I/O ports 510, one or more programmed and executable processes 514, and stored data 516 used by the processes 514. The I/O ports 510 are configured for communication with network devices 520 and/or storage devices such as disk 506. Of course, other computer components may be included and in some embodiments, components may be removed.

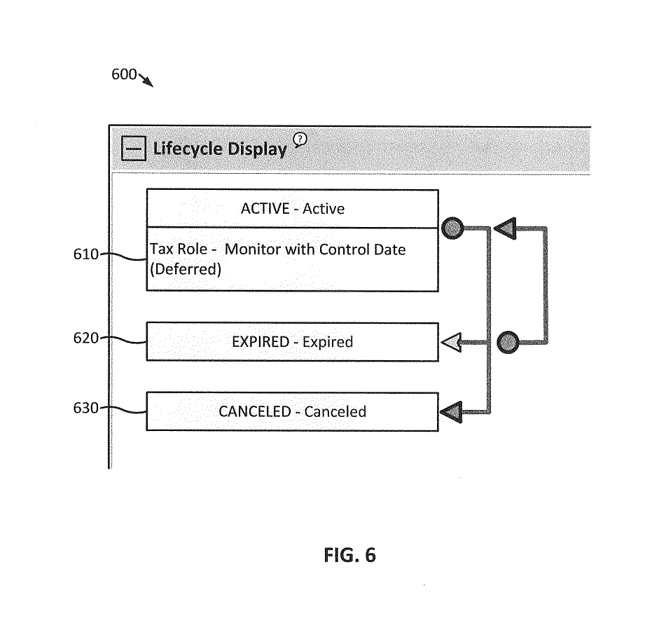

FIG. 6 illustrates one embodiment of a business object lifecycle 600 in accordance with an embodiment wherein the business object is segmented into multiple segments. In FIG. 6, the business object lifecycle 600 is shown in a graphical form displayed on a display screen and is segmented into three (3) segments 610, 620, and 630. The application logic and the enterprise taxation and policy management application logic uses business object definitions to simplify the management of processing logic related to maintaining tax roles over time. Tax roles are used in the example embodiment to define the filing obligations of an entity such as for example a taxpayer for one or more tax types over time.

The business object lifecycle 600 in accordance with the example embodiment helps manage the maintenance processing and rules logic of the application logic while the tax role business object transitions between an active state 610, an expired state 620, and a cancelled state 630. Other states of the business object may be defined and used as desired by specialized users such as application development team members or the like, and the embodiment is not limited to the particular states described herein.

The lifecycle 600 is, in the example embodiment, the backbone of the application logic wherein the lifecycle is executed together with but behind the application logic. The lifecycle 600 provides ready support to various updates and maintenance actions that are performed on the business objects including for example validating changes being made, validating date changes, and the like. Further, whenever a change is made, other actions that may be needed are initiated. When the tax role business object does not change much over time, however, a monitoring system logic executes periodic processes to evaluate the state of a specific tax role object. The monitoring state for the tax role object is illustrated.

It is to be appreciated that the segmentation of the business object lifecycle 600 by the application logic development team provides access points for addition and selective execution of one or more auxiliary or supplemental logic as defined by one or more product implementation teams. To this end, as shown in FIG. 7, an example graphical user interface 700 is shown that is configured to allow one or more auxiliary or supplemental logic for the “Active” state 610 for the tax role object to be added and selectively executed. As shown, in the example embodiment, a set 710 of business object maintenance operations are defined and stored in the system for execution including for example a Transition to Expired logical process 712 and a Generate New Obligations logical process 714. These are represented in the logical process input and display region 720 of the user interface 700. In the example embodiment the Transition to Expired logical process 712 and the Generate New Obligations logical process 714 were generated and stored in the system by the application logic development team. However, the business object lifecycle is segmented for reasons including providing access points for selective execution of auxiliary or supplemental logic as defined by one or more product implementation teams. In the example embodiment, the one or more product implementation teams may selectively add one or more auxiliary or supplemental logic in the logical process input and display region 720 of the user interface 700 for selective execution whenever the lifecycle of the business object transitions to the Active state 610. In one embodiment, the one or more auxiliary or supplemental logic are programmatic logic.

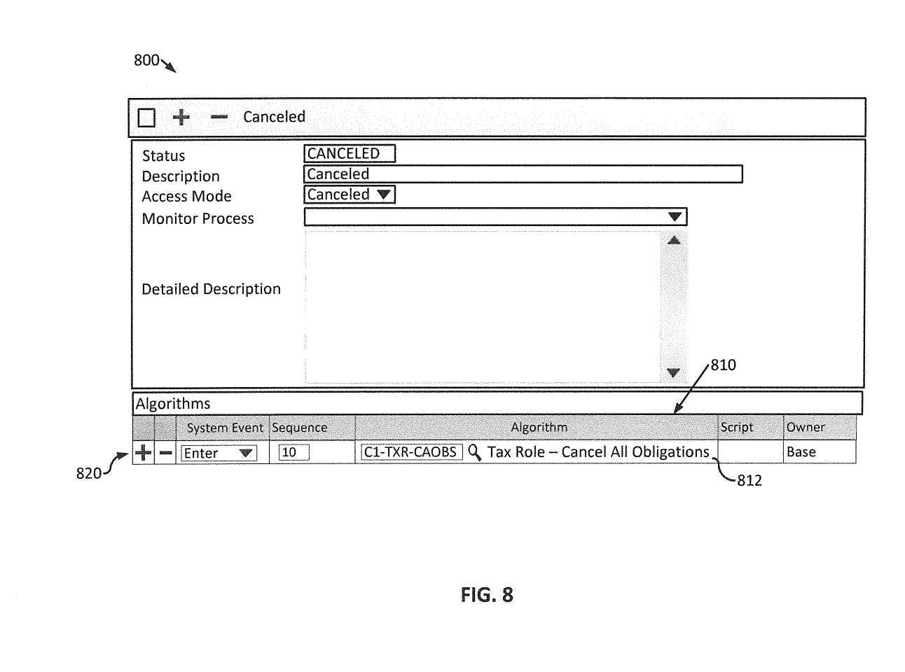

FIG. 8 illustrates one embodiment of an example graphical user interface 800 associated with addition and selective execution of one or more auxiliary or supplemental logic for the “Canceled” state 620 for the tax role object. As shown, in the example embodiment, a set 810 of business object maintenance operations are defined and stored in the system for execution including for example a Cancel All Obligations logical process 812. This is represented in the logical process input and display region 820 of the user interface 800. In the example embodiment, the Cancel All Obligations logical process 812 was generated and stored in the system by the application logic development team. However, the business object lifecycle is segmented to provide access points for selective execution of auxiliary or supplemental logic as previously described. In the example embodiment, the one or more product implementation teams may selectively add one or more auxiliary or supplemental logic in the logical process input and display region 820 of the user interface 800 for selective execution whenever the lifecycle of the business object transitions to the Canceled state 620. In one embodiment, the one or more auxiliary or supplemental logic are programmatic logic.

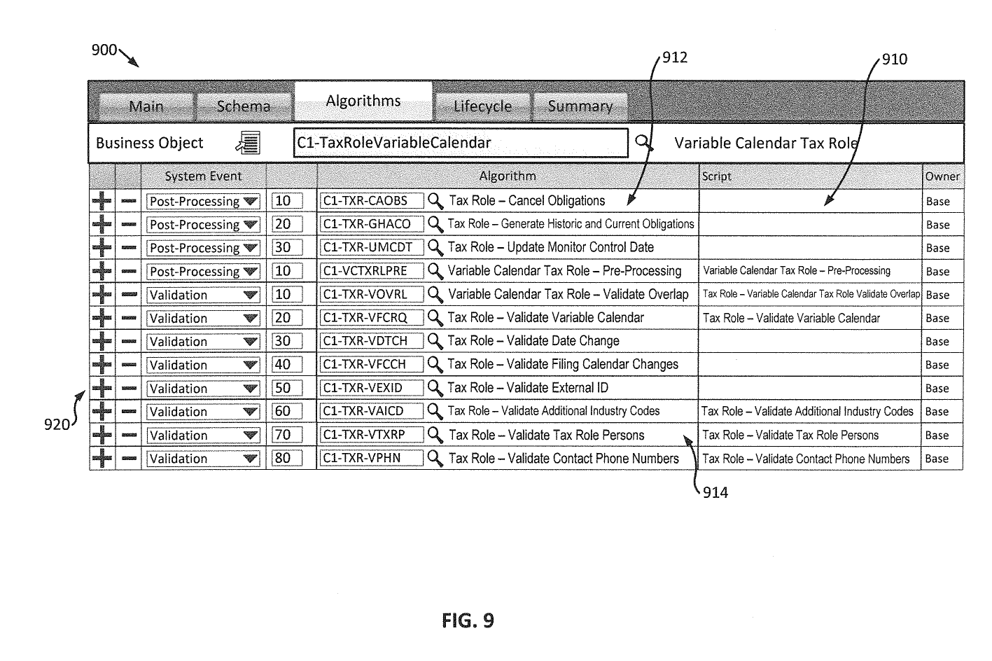

FIG. 9 illustrates one embodiment of an example graphical user interface 900 associated with addition and selective execution of one or more auxiliary or supplemental logic by the system any time a tax role object is added or updated such as, for example, during normal system monitoring absent of any specific or particular state changes. As shown, in the example embodiment, a set 910 of business object maintenance operations are defined and stored in the system for execution including for example a Cancel Obligations logical process 912 and a set of Validate logical processes. This is represented in the logical process input and display region 920 of the user interface 900. In the example embodiment the Cancel Obligations logical process 912 was generated and stored in the system by the application logic development team. However, the business object lifecycle is segmented to provide access points for selective execution of auxiliary or supplemental logic as previously described. In the example embodiment, the one or more product implementation teams may selectively add one or more auxiliary or supplemental logic in the logical process input and display region 920 of the user interface 900 for selective execution whenever a tax role object is added or updated In another embodiment, the described methods and/or their equivalents may be implemented with computer executable instructions. Thus, in one embodiment, a non-transitory computer-readable medium is configured with stored computer executable instructions that when executed by a machine (e.g., processor, computer, and so on) cause the machine (and/or associated components) to perform the method.

While for purposes of simplicity of explanation, the illustrated methodologies in the figures are shown and described as a series of blocks, it is to be appreciated that the methodologies are not limited by the order of the blocks, as some blocks can occur in different orders and/or concurrently with other blocks from that shown and described. Moreover, less than all the illustrated blocks may be used to implement an example methodology. Blocks may be combined or separated into multiple components. Furthermore, additional and/or alternative methodologies can employ additional blocks that are not illustrated. The methods described herein are computer-implemented methods that are performed by at least a processor of a computing device.

The following includes definitions of selected terms employed herein. The definitions include various examples and/or forms of components that fall within the scope of a term and that may be used for implementation. The examples are not intended to be limiting. Both singular and plural forms of terms may be within the definitions.

References to “one embodiment”, “an embodiment”, “one example”, “an example”, and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in one embodiment” does not necessarily refer to the same embodiment, though it may.

“Computer-readable medium”, as used herein, refers to a non-transitory medium that stores instructions and/or data. A computer-readable medium may take forms, including, but not limited to, non-volatile media, and volatile media. Non-volatile media may include, for example, optical disks, magnetic disks, and so on. Volatile media may include, for example, semiconductor memories, dynamic memory, and so on. Common forms of a computer-readable medium may include, but are not limited to, a floppy disk, a flexible disk, a hard disk, a magnetic tape, other magnetic medium, an ASIC, a CD, other optical medium, a RAM, a ROM, a memory chip or card, a memory stick, and other media from which a computer, a processor or other electronic device can read.

“Logic”, as used herein, includes but is not limited to hardware, firmware, a non-transitory computer readable medium that stores instructions, and/or combinations of each to perform a function(s) or an action(s), and/or to cause a function or action from another logic, method, and/or system. Logic may include a microprocessor controlled by an algorithm, a discrete logic (e.g., ASIC), an analog circuit, a digital circuit, a programmed logic device, a memory device containing instructions, and so on. Logic may include one or more gates, combinations of gates, or other circuit components. Where multiple logics are described, it may be possible to incorporate the multiple logics into one physical logic. Similarly, where a single logic is described, it may be possible to distribute that single logic between multiple physical logics.

While example systems, methods, and so on have been illustrated by describing examples, and while the examples have been described in considerable detail, it is not the intention of the applicants to restrict or in any way limit the scope of the appended claims to such detail. It is, of course, not possible to describe every conceivable combination of components or methodologies for purposes of describing the systems, methods, and so on described herein. Therefore, the disclosure is not limited to the specific details, the representative apparatus, and illustrative examples shown and described. Thus, this application is intended to embrace alterations, modifications, and variations that fall within the scope of the appended claims.

To the extent that the term “includes” or “including” is employed in the detailed description or the claims, it is intended to be inclusive in a manner similar to the term “comprising” as that term is interpreted when employed as a transitional word in a claim.

To the extent that the term “or” is used in the detailed description or claims (e.g., A or B) it is intended to mean “A or B or both”. When the applicants intend to indicate “only A or B but not both” then the phrase “only A or B but not both” will be used. Thus, use of the term “or” herein is the inclusive, and not the exclusive use. See, Bryan A. Garner, A Dictionary of Modern Legal Usage 624 (2d. Ed. 1995).

To the extent that the phrase “one or more of, A, B, and C” is used herein, (e.g., a data store configured to store one or more of, A, B, and C) it is intended to convey the set of possibilities A, B, C, AB, AC, BC, and/or ABC (e.g., the data store may store only A, only B, only C, A&B, A&C, B&C, and/or A&B&C). It is not intended to require one of A, one of B, and one of C. When the applicants intend to indicate “at least one of A, at least one of B, and at least one of C”, then the phrasing “at least one of A, at least one of B, and at least one of C” will be used.

What is claimed is:

1. A non-transitory computer-readable medium storing computer-executable instructions that when executed by a computer system including a processor and a non-transient memory cause the system to perform a method, the method comprising:
storing, by at least the processor, a customer tax role record in the non-transient memory of the associated system that includes a plurality of customer tax role records, wherein the customer tax role record being configured with an obligation relationship of an associated customer relative to an associated tax authority, the tax role record comprising a tax role business object;
defining, by at least the processor, a lifecycle for the customer tax role record having a plurality of possible lifecycle states and assigning an initial active state to the customer tax role record;
associating one or more processing algorithms to the customer tax role record that are triggered by predefined events including an expiration date for a tax obligation and a tax obligation period;
subsequently monitoring the plurality of customer tax role records that have an active state, and for a monitored record, determining if the expiration date has expired;
if the expiration date has not expired, generating a new tax obligation for the customer associated with the monitored record;
if the expiration date has expired, changing the state of the lifecycle state of the monitored record to an expired state such that the new tax obligation is not generated; and
repeating the monitoring for a next active record from the plurality of customer tax role records.

2. The non-transitory computer-readable medium of claim 1, further comprising:
associating a custom business record processing logic with a first business record processing logic or a second business record processing logic;
selectively performing the custom business record processing logic on the customer tax role record responsive to performing the first business record processing logic in accordance with the custom business processing logic being associated with the first business record processing logic; and,
selectively performing the custom business record processing logic on the customer tax role record responsive to performing the second business record processing logic in accordance with the custom business processing logic being associated with the second business record processing logic.

3. The non-transitory computer-readable medium of claim 2, wherein:
determining a trigger event by determining a transition of the lifecycle for a monitored record between first and second states of the plurality of possible lifecycle states, wherein the first and second states are mutually different states of the lifecycle;
wherein performing the custom business record processing logic comprises performing the custom business record processing logic responsive to a transition of the lifecycle to the first state for the custom business record processing logic being associated with the first business record processing logic; and,
performing the custom business record processing logic comprises performing the custom business record processing logic responsive to a transition of the lifecycle to the second state for the custom business record processing logic being associated with the second business record processing logic.

4. The non-transitory computer-readable medium of claim 2, wherein:
determining a trigger event that comprises receiving, from a user, update data that modifies the customer tax role record;
performing the first business record processing logic and the custom business record processing logic responsive to receiving the update data that modifies the customer tax role record; and,
wherein selectively performing the custom business record processing logic comprises performing the second business record processing logic and the custom business record processing logic responsive to receiving the update data that modifies the customer tax role record.

5. The non-transitory computer-readable medium of claim 2, wherein:
determining a trigger event that comprises periodically comparing, by the processor, the obligation relationship of the associated customer relative to the associated tax authority with a current time and determining the trigger event in accordance with an unfulfilled obligation based on the periodic comparing;
wherein selectively performing the custom business record processing logic comprises performing the first business record processing logic and the custom business record processing logic responsive to determining the unfulfilled obligation; and,
wherein selectively performing the custom business record processing logic comprises performing the second business record processing logic and the custom business record processing logic responsive to determining the unfulfilled obligation.

6. A non-transitory computer-readable medium storing computer-executable instructions that when executed by a computer system including a processor and a non-transient memory cause the system to perform a method, the method comprising:
storing, by at least the processor, a customer tax role record in the non-transient memory of the associated system, the customer tax role record comprising obligation data representative of an obligation relationship of an associated customer relative to an associated tax authority, the tax role record comprising a tax role business object, the tax role business object comprising a tax role business object lifecycle having a plurality of states representative of selected instances of the tax role business object;
generating, by at least the processor, a business object instance representative of a status of the associated customer relative to the associated entity in accordance with the customer tax role record;
associating first business record processing logic with a first state of the plurality of states of the lifecycle;
associating second business record processing logic with a second state of the plurality of states of the lifecycle;
periodically monitoring a status of the obligation data of the tax role business object relative to a current time;
responsive to determining a change in the status of the obligation data of the tax role business object relative to the current time, determining a state of the lifecycle and performing the first business record processing for the lifecycle being in the first state and performing the second business record processing for the lifecycle being in the second state; and,
receiving custom business record processing logic from a user and selectively performing the custom business record processing logic together with the first or second business processing logic responsive to the determining the change in the status of the obligation data of the tax role business object in accordance with the lifecycle.

7. The non-transitory computer-readable medium of claim 6, further comprising
associating the custom business record processing logic with the first or second business record processing logic;
selectively performing the custom business record processing logic responsive to performing the first business record processing logic in accordance with the associating of the custom business processing logic with the first business record processing logic; and,
selectively performing the custom business record processing logic responsive to performing the second business record processing logic in accordance with the associating of the custom business processing logic with the second business record processing logic.

8. A computing system, comprising:
a processor;
a non-transitory memory coupled with the processor;
the memory having stored therein at least:
a customer tax role record, the customer tax role record being representative of an obligation relationship of an associated customer relative to an associated tax authority, the tax role record comprising a tax role business object, the tax role business object comprising a tax role business object lifecycle having canceled plurality of states representative of selected instances of the tax role business object;
first business record processing logic associated with a first state of the lifecycle and configured to selectively perform first business record processing on the customer tax role record; and
second business record processing logic associated with a second state of the lifecycle and configured to selectively perform second business record processing on the customer tax role record;
business object instance generating logic configured to generate a business object instance representative of a status of the associated customer relative to the associated entity in accordance with the customer tax role record;
a graphical user interface configured to receive update data that modifies the customer tax role record;
the processor, responsive to determining a trigger event, being configured to determine a state of the lifecycle and selectively perform the first business record processing logic if the lifecycle is in the first state and perform the second business record processing logic if the lifecycle is in the second state; and,
wherein in response to receiving custom business record processing logic, the processor is configured to selectively perform the custom business record processing logic responsive to determining the trigger event.

9. The computing system of claim 8, wherein the processor is configured to:
associate the custom business record processing logic with a one of the first or second business record processing logic;
perform the custom business record processing logic responsive to performing the first business record processing logic in accordance with the associating of the custom business processing logic with the first business record processing logic; and,
perform the custom business record processing logic responsive to performing the second business record processing logic in accordance with the associating of the custom business processing logic with the second business record processing logic.

10. The computing system of claim 9, wherein the processor is further configured to:
determine the trigger event by determining a transition of the tax role business object lifecycle between the first and second states of the plurality of states of the lifecycle, wherein the first and second states are mutually different states of the lifecycle;
perform the first custom business processing logic by performing the first custom business processing logic responsive to a transition of the lifecycle to the first state for the custom business record processing logic being associated with the first business record processing logic; and,
perform the second custom business record processing logic by performing the second custom business record processing logic responsive to a transition of the lifecycle to the second state for the custom business record processing logic being associated with the second business record processing logic.

11. The computing system of claim 9, wherein the processor is further configured to:
determine the trigger event by receiving from a user of the computer system by the graphical user interface update data that modifies the customer tax role record;
selectively perform the custom business record processing logic by performing the first business record processing logic and the custom business record processing logic responsive to receiving the update data that modifies the customer tax role record; and,
selectively perform the custom business record processing logic by performing the second business record processing logic and the custom business record processing logic responsive to receiving the update data that modifies the customer tax role record.

12. The computing system of claim 9, wherein the processor is further configured to:
determine the trigger event by periodically comparing the obligation relationship of the associated customer relative to the associated tax authority with a current time and determining the trigger event in accordance with an unfulfilled obligation based on the periodic comparing.

13. The computing system of claim 12, wherein the processor is further configured to:
selectively perform the custom business record processing logic by performing the first business record processing logic and the custom business record processing logic responsive to determining the unfulfilled obligation.

14. The computing system of claim 12, wherein the processor is further configured to:
selectively perform the custom business record processing logic by performing the second business record processing logic and the custom business record processing logic responsive to determining the unfulfilled obligation.

15. A computer-implemented method that is performed by a computer system, the method comprising:
defining, by at least the processor, a lifecycle for a customer tax role record having a plurality of possible lifecycle states and assigning an initial active state to the customer tax role record;
associating, by at least the processor, one or more processing algorithms to the customer tax role record that are triggered by predefined events including an expiration date for a tax obligation and a tax obligation period;
subsequent to the defining and associating, monitoring a plurality of customer tax role records that have an active state, and for a monitored record, determining if the expiration date has expired;
if the expiration date has not expired, generating a new tax obligation for a customer associated with the monitored record using at least one of the processing algorithms associated to the monitored record;
if the expiration date has expired, changing the state of the lifecycle state of the monitored record to an expired state such that the new tax obligation is not generated; and
repeating the monitoring for a next active record from the plurality of customer tax role records.

16. The computer-implemented method of claim 15, further comprising:
storing, by at least the processor, a customer tax role record in a non-transient memory of the computer system that includes the plurality of customer tax role records, wherein the customer tax role record is configured with an obligation relationship of an associated customer relative to an associated tax authority, and wherein customer the tax role record comprises a tax role business object.

17. The computer-implemented method of claim 15, further comprising associating a custom business record processing logic with a first record processing logic or a second record processing logic.

18. The computer-implemented method of claim 17, further comprising
selectively performing the custom business record processing logic on the customer tax role record responsive to performing the first record processing logic in accordance with the custom business processing logic being associated with the first record processing logic.

19. The computer-implemented method of claim 17, further comprising
selectively performing the custom business record processing logic on the customer tax role record responsive to performing the second record processing logic in accordance with the custom business processing logic being associated with the second record processing logic.

20. The computer-implemented method of claim 15, further comprising:
determining a trigger event that comprises periodically comparing, by the processor, the tax obligation of an associated customer relative to a tax authority with a current time and determining the trigger event in accordance with an unfulfilled obligation based on the periodic comparing.
